(19) United States
(12) Patent Application Publication
(10) Pub. No.: US 2026/0120001 A1
(43) Pub. Date: Apr. 30, 2026

(54) MACHINE LEARNING MODEL INPUT QUERY ROUTING

(71) Applicant: INTUIT INC., Mountain View, CA (US)

(72) Inventors: Rami COHEN, Ashkelon (IL); Matan VETZLER, Givat Shmue'l (IL); Osnat Haj YAHIA, Taybe (IL); Shai ARDAZI, Petach Tikva (IL)

(21) Appl. No.: 18/934,065

(22) Filed: Oct. 31, 2024

(51) Int. Cl. G06N 20/20

(52) U.S. Cl. CPC G06N 20/20

(57) ABSTRACT

Aspects of the present disclosure relate to customized routing of input queries in machine learning models. Embodiments include receiving one or more inputs to an ensemble model containing a plurality of expert models. Embodiments further include routing the one or more inputs through a gating component in the ensemble model to a subset of the plurality of expert models based on a number of parameters in the subset of the plurality of expert models. Embodiments further include generating one or more outputs based on processing the one or more inputs through the subset of the plurality of expert models.

### INTRODUCTION

Aspects of the present disclosure relate to techniques for customized routing of input queries in machine learning models. In particular, techniques described herein involve using a gating mechanism within an ensemble model to route queries, based on complexity, to one or more expert models having the smallest number of parameters necessary to provide an accurate output.

### BACKGROUND

Every year, millions of people, businesses, and organizations around the world use software applications to assist with countless aspects of life. Because of the widespread use of machine learning models, including large language models, in software applications, a vast amount of computing resources is devoted to run those models. In particular, some machine learning models, like large language models, often utilize billions or trillions of parameters to generate outputs. While those models are able to process natural language prompts and accurately generate a desired output in response to an input query, the models do so at great costs. For example, large language models are associated with significant computational costs, energy consumption, and resource inefficiencies.

Large language models often utilize an ensemble approach, where the model contains multiple sub-models or “expert” models. For instance, inputs may be routed to appropriate expert models, which may generate an appropriate output. Existing techniques generally involve loading all of the expert models contained in an ensemble model when an input is received for processing and/or utilizing an expert model with a highest overall accuracy (e.g., which is generally an expert model with a relatively large number of parameters). Many expert models may contain billions or trillions of parameters. This causes inefficiencies, resulting in high memory requirements, computational costs, and energy consumption.

Thus, there is a need in the art for improved techniques for generating outputs using ensemble machine learning models.

### BRIEF SUMMARY

Certain embodiments provide a method of customized routing of input queries in machine learning models. The method generally includes: receiving one or more inputs to an ensemble model containing a plurality of expert models; routing the one or more inputs through a gating component in the ensemble model to a subset of the plurality of expert models based on a number of parameters in the subset of the plurality of expert models; and generating one or more outputs based on processing the one or more inputs through the subset of the plurality of expert models.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to customized routing of input queries in machine learning models.

FIG. 2 depicts an example of workflow related to customized routing of input queries in machine learning models.

FIG. 3 depicts example operations related to customized routing of input queries in machine learning models.

FIG. 4 depicts additional example operations related to customized routing of input queries in machine learning models.

FIG. 5 depicts an example of a processing system for customized routing of input queries in machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for customized routing of input queries in machine learning models.

According to some embodiments, a machine learning model, such as a large language model, may receive one or more inputs. For example, the large language model may be an ensemble model which may contain a plurality of expert models. The expert models may each contain a certain number of parameters. The ensemble model may further contain a gating component that may route the one or more inputs to a subset of the plurality of expert models. In certain embodiments, in order to improve the resource-efficiency of the ensemble model, the routing may be based on the number of parameters contained in the subset of the plurality of the expert models. For example, a subset of the plurality of expert models containing a smallest number of parameters required to generate the one or more outputs with a target level of accuracy may be predicted based on historical data provided to the gating component. The predicting may be performed dynamically by the gating component. The routing may be further based on the capabilities of the plurality of expert models. One or more outputs may then be generated based on processing the one or more inputs through the subset of the plurality of expert models chosen by the gating component.

According to some embodiments, an action may be performed in a software application based on the one or more outputs from the ensemble model. For example, actions may include generating new content based on the one or more outputs, populating one or more variables based on the one or more outputs, displaying information via a user interface based on the one or more outputs, or a combination thereof.

Certain embodiments provide that the machine learning model may be trained by first providing inputs, based on labeled training data, to the ensemble model containing the gating component and the expert models. The outputs received from the ensemble model based on processing the inputs by a certain subsets of the expert models may then be compared to labels associated with the inputs in the labeled training data. Based on the comparing, parameters of the ensemble model may be iteratively adjusted, wherein the gating component is trained to route given inputs to respective subsets of the expert models based on numbers of model parameters associated with the respective subsets. In some embodiments, training the gating component further comprises analyzing the outputs from the ensemble model based on the subsets of the expert models that were used to produce the outputs in order to determine a target subset of the expert models. For example, the target subset may comprise a subset of the expert models containing the smallest number of parameters required to generate a corresponding output with a target level of accuracy. The target subset may be stored in corresponding labeled training data for the gating component and the gating component may be trained based on the labeled training data for the gating component. According to other embodiments, the ensemble model may be trained by penalizing, based on a loss function, routing of the inputs to a subset of the expert models with more model parameters than required to generate a corresponding output with a target level of accuracy. For example, such a loss function may include a component that penalizes utilizing expert models with large amounts of model parameters as well as a component that penalizes inaccuracy.

Embodiments of the present disclosure provide numerous technical and practical effects and benefits. Existing techniques for implementing language processing models that utilize expert models generally require all expert models (which themselves contain a number of parameters) contained therein to be loaded or an expert model that is most likely to produce an accurate result to be used (which generally results in the largest applicable expert model in terms of parameters being used), which results in high energy consumption and computational costs. The present disclosure solves these technical problems. For example, rather than running all of the expert models contained in the ensemble model or even running an expert model that is most likely to be accurate (e.g., which is also usually an expert model with a relatively large number of parameters), techniques described herein route, by a gating mechanism, inputs, or a set of inputs, to only a set of one or more expert models that have a smallest number of parameters (e.g., of all potential applicable sets of one or more expert models) while still producing the corresponding output(s) with a target level of accuracy. The number of expert models and the number of parameters in such a set of expert models is typically significantly fewer than the total number contained in the model and significantly fewer than the number of parameters that would otherwise be included in a set of expert models that was selected based only on accuracy and not on numbers of model parameters. Because the present disclosure does not require loading all X number of parameters across the expert models in the ensemble model, but only a smaller subset of those X parameters (e.g., Y parameters where Y<X), the computing power required to achieve an output with the same accuracy as existing techniques is thereby decreased. Therefore, overall computing efficiency is also increased, as far less energy is needed to produce the same results. Furthermore, through training the ensemble model and/or the gating mechanism, by utilizing a loss function for example, the gating mechanism may automatically predict the smallest number of parameters needed to accurately produce the corresponding output and route the inputs accordingly, optimizing the efficiency of the model and overall computing system. Thus, techniques described herein reduce the amounts of computing resources utilized by an ensemble model that includes multiple expert models while producing results with a high level of accuracy.

### Example of Computing Components Related to Customized Routing of Input Queries in Machine Learning Models

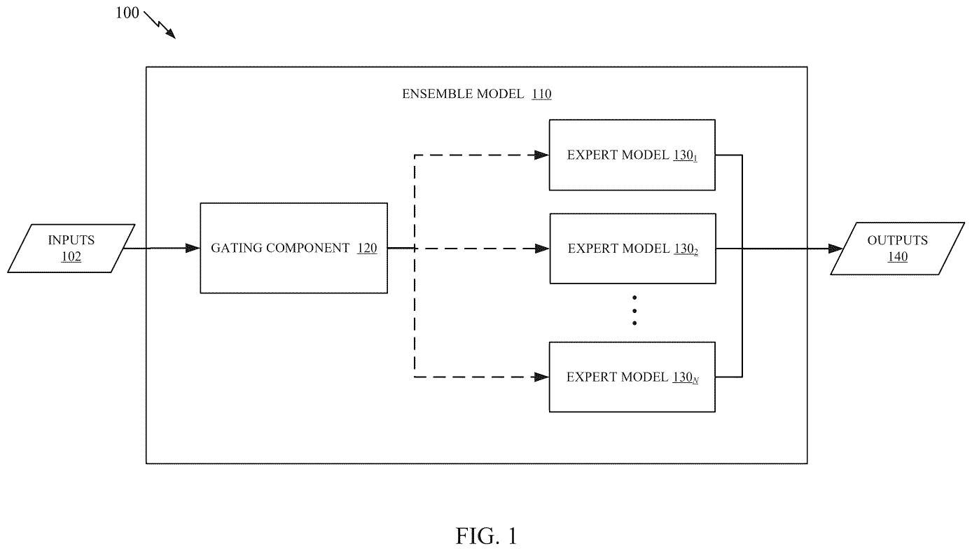

FIG. 1 depicts an example of computing components related to customized routing of input queries in machine learning models.

An ensemble model 110 may comprise one or more machine learning models. In a particular example, ensemble model 110 comprises one or more language processing machine learning models such as a large language model (LLM). For example, ensemble model 110 may have been trained on a large training data set in order to process natural language inputs and generate natural language content in response. In some embodiments, ensemble model 110 comprises a generative pre-trained transformer (GPT) model that has been trained on a large set of training data (e.g., across a plurality of domains), and is capable as a result of such training to perform a wide variety of language-related tasks in response to natural language prompts. In some embodiments, ensemble model 110 has been fine-tuned for one or more particular domains, such as for use with a particular software application or for a specific purpose, while in other embodiments ensemble model 110 has been trained in a more general fashion and has not been fine-tuned in such a manner. Ensemble model 110 may have a large number of tunable parameters, which are iteratively adjusted during a model training process based on training data. In alternative embodiments, ensemble model 110 may include one or more other types of machine learning models. For example, ensemble model 110 may include one or more generative adversarial networks (GANs), autoencoder models, autoregressive models, diffusion models, Bayesian networks, hidden Markov models, tree-based models, neural networks, regression models, and/or the like.

The ensemble model 110 may contain N number of expert models 130_{1-N}. Those expert models 130 may each be trained on one particular subject matter or on a variety of subject matters. Each expert model 130 contained in the ensemble model 110 may be a type of machine learning model, such as a neural network. According to certain embodiments, the expert models may vary in size. For example, expert model 130₁ may compromise a certain architecture with A number of layers while expert model 130₂ may comprise a different architecture with B number of layers, and so on. Each layer may correspond to a specified number of parameters. The ensemble model 110 may also contain a gating component 120. In some embodiments, the gating component 120 may be a multi-label classifier or another type of machine learning model component. Gating component 120 may be trained, for example, using labeled training data associated with target subsets of the N expert models 130 contained in the ensemble model 110.

The ensemble model 110 may receive one or more inputs 102. For example, the input(s) 102 may be a natural language query provided by a user. The gating component 120 may first predict the smallest subset of the expert models 130 (e.g., the combination of one or more expert models that contain the lowest number of parameters) capable of processing the one or more inputs and generating one or more accurate (e.g., meeting a threshold level of predicted accuracy) outputs in response. In some embodiments, gating component 120 makes such a prediction implicitly (e.g., as a result of its training) by selecting a subset of expert models 130 to which to route inputs 102 based on one or more attributes of inputs 102. The gating component 120 may then route the one or more inputs 102 received by the ensemble model 110 to those one or more of the expert models 130 contained in the ensemble model 110. For example, simple queries may be routed to a relatively small expert model or a relatively small combination of expert models, while complex queries may be routed to a relatively larger expert model or a relatively larger combination of expert models. Therefore, only a subset of the one or more expert models contained in the ensemble model 110 may be utilized for a given set of inputs. These techniques allow for a larger machine learning model to be used when processing complex input queries with accuracy while conserving computing resources when processing relatively simpler input queries.

Once the one or more inputs are routed to the one or more expert models 130 chosen by the gating component 120, the one or more expert models 130 may process the inputs and the corresponding output(s) 140 may be generated. In one example, the generating may comprise aggregating the respective output(s) from each of the expert models in the one or more selected expert models 130 by calculating a mean (e.g., if more than one expert model is used). In another example, the aggregation may comprise a linear transformation, performed, for example, by a linear layer in a neural network.

### Example Workflow Related to Customized Routing of Input Queries in Machine Learning Models

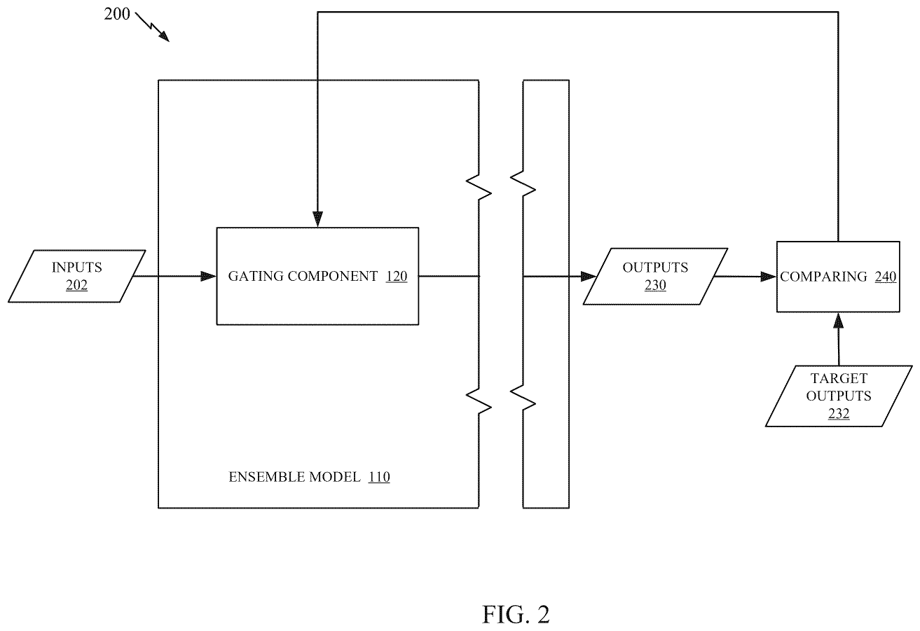

FIG. 2 depicts an example workflow 200 related to customized routing of input queries in machine learning models. For example, workflow 200 depicts steps that may be performed to train the gating mechanism 120 of ensemble model 110 of FIG. 1.

The ensemble model 110 may receive inputs 202. For example, inputs 202 may be a set of sample queries. The gating component 120 may select a target subset of expert models (e.g., a subset of the expert models containing the smallest number of parameters required to generate a corresponding output with a target level of accuracy) and route the inputs 202 through the ensemble model 110 accordingly, producing outputs 230. Comparing 240 may be then performed wherein the outputs 230 may be compared to target outputs 232. For example, comparing 240 may comprise manual review of the outputs 230 in order to determine whether the outputs 230 were routed through a subset of the expert models containing more parameters than required and whether the outputs 230 achieved a target level of accuracy (e.g., ensemble model 110 may also output indications of which expert model(s) were used to generate each output 230 and, in some embodiments, indications of the number of parameters in each such expert model, and these indications may be reviewed along with outputs 230 to determine which expert model(s) produced accurate outputs and, of these, which expert model(s) have the fewest parameters). In another example, comparing 240 comprises automated review of the outputs 230, such as by utilizing a language processing machine learning model as a judge to determine which output(s) 230 are correct and identifying which correct output(s) 230 were produced by combinations of expert models having the fewest parameters. Target outputs 232 may represent expected outputs for inputs 202, such as based on manual review, use of a language processing machine learning model as a judge, labeled training data, and/or the like.

In some embodiments, the inputs 202 may be routed to all possible combinations of expert models. The outputs 230 produced from the inputs 202 may then be analyzed (e.g., at comparing 240) to determine which subset of the expert models that both contains the smallest number of parameters and produces outputs with a target level of accuracy. The target subset may then be stored in the labeled training data used to train the gating component 120. For example, the arrow from comparing 240 to gating component 120 may represent training of gating component 120 using training data that is based on comparing 240. Training of gating component 120 may involve a supervised learning process by which training inputs are provided to gating component 120, gating component 120 selects sets of expert models to handle the training inputs, the selected sets of expert models are compared to labels associated with the training inputs in the training data, and parameters of gating component 120 are iteratively adjusted based on the comparing until one or more conditions are met (e.g., until the selected sets of expert models match the labels, and/or the like).

In other embodiments, a custom loss function is used to train the ensemble model 110. In the context of training a machine learning model, the function used to evaluate a candidate solution may be referred to as the objective function. Optimizing an objective function may involve either maximizing or minimizing the objective function, which generally involves searching for a candidate solution that has the highest or lowest score. Generally, training a machine learning model involves minimizing error and, accordingly, the objective function may be referred to as a loss function (or sometimes a cost function). The value calculated by the loss function is referred to as loss. In some embodiments where the model is trained to generate accurate outputs using the fewest parameters, a custom loss function may penalize the model when it does not use a combination of the expert models containing the fewest parameters (i.e., when it uses a combination of expert models with more parameters than necessary to produce the output(s) with the target level of accuracy). Therefore, the ensemble model 110 will continuously be guided towards optimizing efficiency in the expert model selection while still maintaining accuracy in its outputs.

In another embodiment, techniques described herein can be performed with tree-based models using other applicable machine learning model training techniques.

### Example Operations Related to Customized Routing of Input Queries in Machine Learning Models

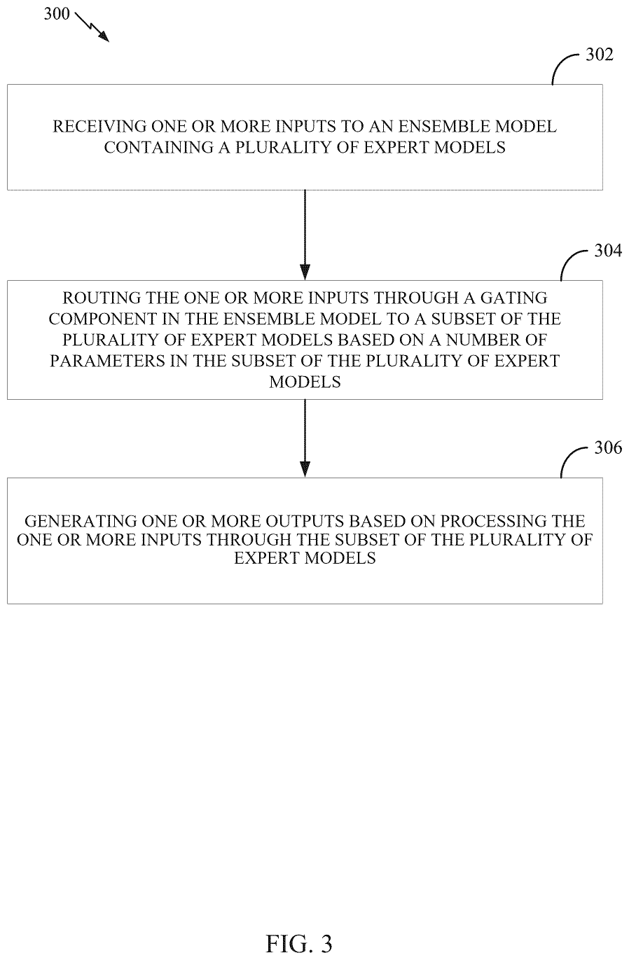

FIG. 3 depicts example operations 300 related to customized routing of input queries in machine learning models. For example, operations 300 may be performed by one or more of the components described with respect to FIG. 1 and/or FIG. 2.

Operations 300 begin at step 302 with receiving one or more inputs to an ensemble model containing a plurality of expert models.

Operations 300 continue at step 304 with routing the one or more inputs through a gating component in the ensemble model to a subset of the plurality of expert models based on a number of parameters in the subset of the plurality of expert models. In some embodiments, the routing of the one or more inputs through the gating component to the subset of the plurality of expert models based on the number of parameters in the subset of the plurality of expert models comprises predicting, based on historical data, that the subset of the plurality of expert models contains a smallest number of parameters required to generate the one or more outputs with a target level of accuracy. According to certain embodiments, the predicting, based on the historical data, that the subset of the plurality of expert models contains the smallest number of parameters required to generate the one or more outputs with the target level of accuracy is performed dynamically by the gating component based on the one or more inputs. Some embodiments provide that the routing of the one or more inputs through the gating component in the ensemble model to the subset of the plurality of expert models is further based on capabilities of the plurality of expert models.

Operations 300 continue at step 306 with generating one or more outputs based on processing the one or more inputs through the subset of the plurality of expert models.

In certain embodiments, the method further comprises performing an action within a software application based on the one or more outputs. Some embodiments provide that the performing the action within the software application based on the one or more outputs comprises one or more of: generating new content based on the one or more outputs; populating one or more variables based on the one or more outputs; or displaying information via a user interface based on the one or more outputs.

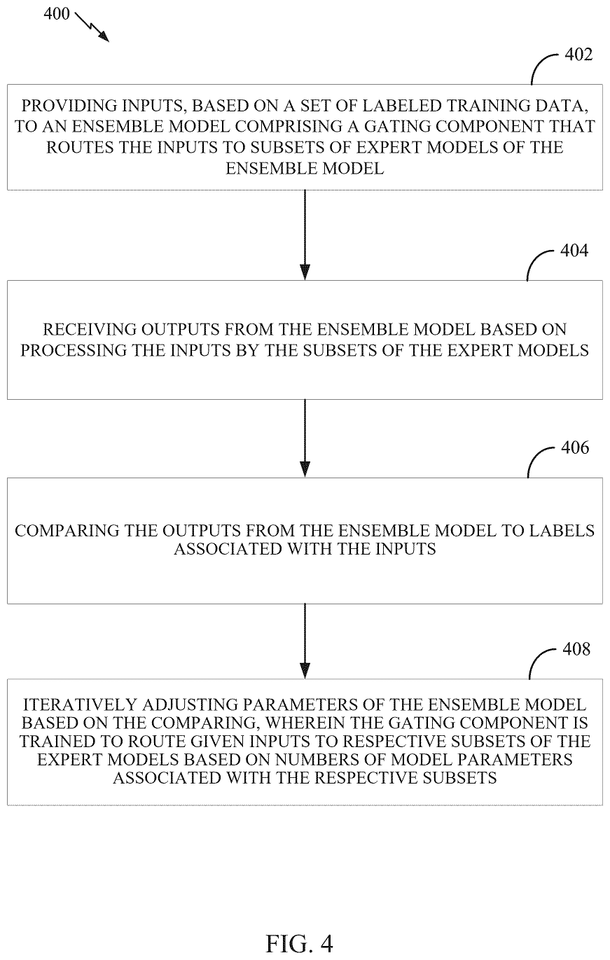

FIG. 4 depicts additional example operations 400 related to customized routing of input queries in machine learning models. For example, operations 400 may be performed by one or more of the components described with respect to FIG. 1 and/or FIG. 2.

Operations 400 begin at step 402 with providing inputs, based on a set of labeled training data, to an ensemble model comprising a gating component that routes the inputs to subsets of expert models of the ensemble model.

Operations 400 continue at step 404 with receiving outputs from the ensemble model based on processing the inputs by the subsets of the expert models.

Operations 400 continue at step 406 with comparing the outputs from the ensemble model to labels associated with the inputs.

Operations 400 continue at step 408 with iteratively adjusting parameters of the ensemble model based on the comparing, wherein the gating component is trained to route given inputs to respective subsets of the expert models based on numbers of model parameters associated with the respective subsets.

In certain embodiments, the method further comprises analyzing the outputs from the ensemble model based on the subsets of the expert models that were used to produce the outputs; determining a target subset of the expert models, wherein the target subset comprises a subset of the expert models containing a smallest number of parameters required to generate a corresponding output with a target level of accuracy; storing the target subset in corresponding labeled training data for the gating component; and training the gating component based on the labeled training data for the gating component. Some embodiments provide that the method further comprises penalizing, based on a loss function, routing of the inputs to a subset of the expert models with more model parameters than required to generate a corresponding output with a target level of accuracy.

### Example of a Processing System for Customized Routing of Input Queries in Machine Learning Models

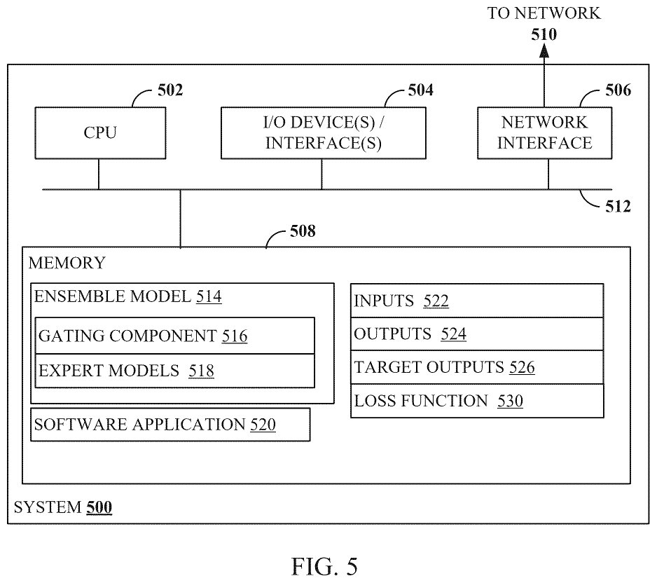

FIG. 5 illustrates an example system 500 with which embodiments of the present disclosure may be implemented. For example, system 500 may be configured to perform operations 300 of FIG. 3, to perform operations 400 of FIG. 4, and/or to implement one or more components as in FIG. 1 or FIG. 2.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes ensemble model 514 (including gating component 516 and expert models 518) and software application 520. Ensemble model 514 may be representative of ensemble model 110 of FIG. 1 and FIG. 2. Gating component 516 may be representative of gating component 120 of FIG. 1 and FIG. 2. Expert models 518 may be representative of expert models 130 of FIG. 1. Software application 520 may be used to generate new content, populate one or more variables, display information to a user, and/or the like, such as based on utilizing ensemble model 514.

Memory 508 further comprises inputs 522 which may correspond to inputs 102 of FIG. 1 and/or inputs 202 of FIG. 2. Memory 508 further comprises outputs 524, which may correspond to outputs 140 of FIG. 1 and outputs 230 of FIG. 2. Memory 508 further comprises target outputs 526, which may correspond to target outputs 232 of FIG. 2. Memory 508 further comprises loss function 530, which may represent a loss function that is used to train ensemble model 514, and which may include a component that penalizes utilizing expert models with large numbers of parameters (e.g., the more parameters, the higher the penalty) and a component that penalizes inaccurate results. It is noted that in some embodiments, system 500 may interact with one or more external components, such as via network 510, in order to retrieve data and/or perform operations. Furthermore, techniques described herein may be implemented via more or fewer components than those shown and described with respect to FIG. 5, such as on one or more computing systems.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining”may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S. C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for customized routing of input queries in machine learning models, comprising:
receiving one or more inputs to an ensemble model containing a plurality of expert models;
routing the one or more inputs through a gating component in the ensemble model to a subset of the plurality of expert models based on a number of parameters in the subset of the plurality of expert models; and
generating one or more outputs based on processing the one or more inputs through the subset of the plurality of expert models.

2. The method of claim 1, wherein the routing of the one or more inputs through the gating component to the subset of the plurality of expert models based on the number of parameters in the subset of the plurality of expert models comprises predicting, based on historical data, that the subset of the plurality of expert models contains a smallest number of parameters required to generate the one or more outputs with a target level of accuracy.

3. The method of claim 2, wherein the predicting, based on the historical data, that the subset of the plurality of expert models contains the smallest number of parameters required to generate the one or more outputs with the target level of accuracy is performed dynamically by the gating component based on the one or more inputs.

4. The method of claim 1, wherein the gating component is trained based on one or more of:
providing one or more sets of inputs to the gating component and comparing one or more sets of resulting outputs from processing the one or more sets of inputs through the ensemble model to one or more sets of target outputs corresponding to the one or more sets of inputs; or
penalizing, based on a loss function, routing of inputs to subsets of the plurality of expert models with more parameters than required to generate corresponding outputs with a target level of accuracy.

5. The method of claim 1, further comprising performing an action within a software application based on the one or more outputs.

6. The method of claim 5, wherein the performing the action within the software application based on the one or more outputs comprises one or more of:
generating new content based on the one or more outputs;
populating one or more variables based on the one or more outputs; or
displaying information via a user interface based on the one or more outputs.

7. The method of claim 1, wherein the routing of the one or more inputs through the gating component in the ensemble model to the subset of the plurality of expert models is further based on capabilities of the plurality of expert models.

8. A method for machine learning model training, comprising:
providing inputs, based on a set of labeled training data, to an ensemble model comprising a gating component that routes the inputs to subsets of expert models of the ensemble model;
receiving outputs from the ensemble model based on processing the inputs by the subsets of the expert models;
comparing the outputs from the ensemble model to labels associated with the inputs; and
iteratively adjusting parameters of the ensemble model based on the comparing, wherein the gating component is trained to route given inputs to respective subsets of the expert models based on numbers of model parameters associated with the respective subsets.

9. The method of claim 8, further comprising:
analyzing the outputs from the ensemble model based on the subsets of the expert models that were used to produce the outputs;
determining a target subset of the expert models, wherein the target subset comprises a subset of the expert models containing a smallest number of parameters required to generate a corresponding output with a target level of accuracy;
storing the target subset in corresponding labeled training data for the gating component; and
training the gating component based on the labeled training data for the gating component.

10. The method of claim 8, further comprising penalizing, based on a loss function, routing of the inputs to a subset of the expert models with more model parameters than required to generate a corresponding output with a target level of accuracy.

11. A system for customized routing of input queries in machine learning models, comprising:
one or more processors; and
a memory comprising instructions that, when executed by the one or more processors, cause the system to:
receive one or more inputs to an ensemble model containing a plurality of expert models;
route the one or more inputs through a gating component in the ensemble model to a subset of the plurality of expert models based on a number of parameters in the subset of the plurality of expert models; and
generate one or more outputs based on processing the one or more inputs through the subset of the plurality of expert models.

12. The system of claim 11, wherein the routing of the one or more inputs through the gating component to the subset of the plurality of expert models based on the number of parameters in the subset of the plurality of expert models comprises predicting, based on historical data, that the subset of the plurality of expert models contains a smallest number of parameters required to generate the one or more outputs with a target level of accuracy.

13. The system of claim 12, wherein the predicting, based on the historical data, that the subset of the plurality of expert models contains the smallest number of parameters required to generate the one or more outputs with the target level of accuracy is performed dynamically by the gating component based on the one or more inputs.

14. The system of claim 11, wherein the gating component is trained based on one or more of:
providing one or more sets of inputs to the gating component and comparing one or more sets of resulting outputs from processing the one or more sets of inputs through the ensemble model to one or more sets of target outputs corresponding to the one or more sets of inputs; or
penalizing, based on a loss function, routing of inputs to subsets of the plurality of expert models with more parameters than required to generate corresponding outputs with a target level of accuracy.

15. The system of claim 11, wherein the instructions, when executed by the one or more processors, further cause the system to perform an action within a software application based on the one or more outputs.

16. The system of claim 15, wherein the performing the action within the software application based on the one or more outputs comprises one or more of:
generating new content based on the one or more outputs;
populating one or more variables based on the one or more outputs; or
displaying information via a user interface based on the one or more outputs.

17. The system of claim 11, wherein the routing of the one or more inputs through the gating component in the ensemble model to the subset of the plurality of expert models is further based on capabilities of the plurality of expert models.

18. A system for machine learning model training, comprising:
one or more processors; and
a memory comprising instructions that, when executed by the one or more processors, cause the system to:
provide inputs, based on a set of labeled training data, to an ensemble model comprising a gating component that routes the inputs to subsets of expert models of the ensemble model;
receive outputs from the ensemble model based on processing the inputs by the subsets of the expert models;
compare the outputs from the ensemble model to labels associated with the inputs; and
iteratively adjust parameters of the ensemble model based on the comparing, wherein the gating component is trained to route given inputs to respective subsets of the expert models based on numbers of model parameters associated with the respective subsets.

19. The system of claim 18, further comprising:
analyzing the outputs from the ensemble model based on the subsets of the expert models that were used to produce the outputs;
determining a target subset of the expert models, wherein the target subset comprises a subset of the expert models containing a smallest number of parameters required to generate a corresponding output with a target level of accuracy;
storing the target subset in corresponding labeled training data for the gating component; and
training the gating component based on the labeled training data for the gating component.

20. The system of claim 18, further comprising penalizing, based on a loss function, routing of the inputs to a subset of the expert models with more model parameters than required to generate a corresponding output with a target level of accuracy.
